(19) United States
(12) Patent Application Publication
(10) Pub. No.: US 2025/0388994 A1
(43) Pub. Date: Dec. 25, 2025

(54) METHOD FOR EXTRACTING LITHIUM FROM LITHIUM-CONTAINING MATERIAL

(71) Applicant: SOGANG UNIVERSITY RESEARCH & BUSINESS DEVELOPMENT FOUNDATION, Seoul (KR)

(72) Inventors: Nam-Hwi HUR, Seoul (KR); Hee Sun PARK, Seoul (KR)

(73) Assignee: SOGANG UNIVERSITY RESEARCH & BUSINESS DEVELOPMENT FOUNDATION, Seoul (KR)

(21) Appl. No.: 19/316,159

(22) Filed: Sep. 2, 2025

Related U.S. Application Data
(63) Continuation of application No. PCT/KR2024/002666, filed on Feb. 29, 2024.

(30) Foreign Application Priority Data
Mar. 2, 2023 (KR) 10-2023-0027727
Mar. 21, 2023 (KR) 10-2023-0036531
Jan. 9, 2024 (KR) 10-2024-0003500

(51) Int. Cl. C22B 3/04; B01J 23/46; C22B 1/00; C22B 26/12

(52) U.S. Cl. CPC C22B 3/04; B01J 23/462; C22B 1/005; C22B 26/12

(57) ABSTRACT

The present application relates to a method for extracting lithium from a lithium-containing material. The lithium extraction method according to implementations of the present application can extract lithium from a lithium-containing material through a single process rather than through a conventional hydrometallurgical process.

### CROSS-REFERENCE TO RELATED APPLICATION

This application is a continuation application of International Application No. PCT/KR2024/002666 filed on Feb. 29, 2024 which claims the benefit of priority from Korean Patent Application No. 10-2023-0027727 filed on Mar. 2, 2023, Korean Patent Application No. 10-2023-0036531 filed on Mar. 21, 2023 and Korean Patent Application No. 10-2024-0003500 filed on Jan. 9, 2024, and designating the U.S., the entire contents of which are incorporated herein by reference.

### TECHNICAL FIELD

The present application relates to a method for extracting lithium from a lithium-containing material.

### BACKGROUND ART

The recent increase in demand for lithium metal is closely related to the rapid demand for electric vehicle batteries. In recent years, over 70% of the demand for lithium metal is driven by lithium secondary batteries, and this demand is expected to steadily increase alongside the growing trend of electric vehicles. Lithium is currently produced and supplied through a hard rock method of extracting lithium from ore; and a brine method of producing lithium through an evaporation process from lake water having a high salt concentration. While the proportions of lithium produced by these two methods are similar, brine is reported to have a larger reserve when they are calculated by reserves.

Among brine methods, the most widely used method is to extract lithium in the form of lithium carbonate (Li₂CO₃) through chemical treatment. This process utilizes sodium carbonate (Na₂CO₃), which has a higher solubility in water than lithium carbonate having low solubility in water, to obtain lithium ions in the brine as a lithium carbonate precipitate. This precipitation reaction may be efficiently performed when the pH of the brine is 10 or higher, and sodium hydroxide (NaOH) is mainly used to adjust the pH. Excess sodium ions present in the solution are separated through a washing process.

The chemical extraction method that utilizes the difference in solubility has an advantage of being able to obtain lithium in the form of lithium carbonate with a relatively simple process, but it has the disadvantage of requiring large amounts of sodium carbonate and sodium hydroxide and discharging a large amount of wastewater. Therefore, the chemical extraction method has the problem in that the process management and environmental costs become very high as the scale of the extraction process increases.

Meanwhile, the methods for extracting lithium from lithium-containing ores such as spodumene (LiAlSi₂O₆), petalite (LiAlSi₄O₁₀), and eucryptite (LiAlSiO₄) may be divided into pyrometallurgical and hydrometallurgical methods. The technology for extracting lithium using a pyrometallurgical method has a simple process and produces less residual impurities, which may significantly reduce the problem of environmental pollution caused by wastewater compared to the hydrometallurgical method, but this technology consumes a lot of energy because it requires a high-temperature environment of 1,000° C. or higher. On the other hand, the hydrometallurgical method is advantageous in that it may selectively separate only lithium metal and has low energy costs, but it has the disadvantage of generating a large amount of sulfuric acid wastewater and taking a long process time due to its complex process.

Therefore, research is ongoing to develop an environmentally-friendly and economical lithium extraction process capable of extracting lithium from lithium-containing materials while minimizing the use of chemicals and reducing wastewater generation. Accordingly, when a lithium raw material, one of the important variables in manufacturing lithium ion batteries, can be supplied at low cost, it is expected to greatly contribute to the revitalization of related fields such as electric vehicles and the like.

### RELATED-ART DOCUMENT

Korean Patent No. 10-1911633

### DISCLOSURE

### Technical Problem

The present application is directed to providing a method for extracting lithium from a lithium-containing material.

However, technical problems to be solved by the present application are not limited to the problems described above, and other problems not mentioned herein may be clearly understood by those skilled in the art from the description of the present application described below.

### Technical Solution

According to a first aspect of the present application, there is provided a method for extracting lithium, which includes: obtaining lithium by catalytically reacting a lithium-containing material; nitric acid or nitrate ions; and hydrogen.

According to a second aspect of the present application, there is provided a ruthenium oxide catalyst that is represented by the following Chemical Formula I and has a monoclinic crystal structure, wherein the ruthenium oxide catalyst is used in the lithium extraction method according to the first aspect:

[Chemical Formula I]

HₓRuO₂
wherein 0<x≤4.

### Advantageous Effects

The lithium extraction method according to the exemplary embodiments of the present application can extract lithium from a lithium-containing material through a single process, compared to a conventional hydrometallurgical process.

The lithium extraction method according to the exemplary embodiments of the present application can simultaneously prepare expensive ammonia compounds.

The yield of lithium that may be obtained using the lithium extraction method according to the embodiments of the present application can be approximately 30% or more, approximately 40% or more, approximately 50% or more, approximately 60% or more, approximately 70% or more, approximately 80% or more, approximately 85% or more, approximately 90% or more, approximately 95% or more, approximately 98% or more, or approximately 99% or more.

The catalyst used in the lithium extraction method according to the exemplary embodiments of the present application does not melt or its structure does not collapse during the reaction, and thus is economical because the reaction can be performed for a long time and it can be separated and recovered after the reaction, and then reused.

The lithium extraction method according to the exemplary embodiments of the present application can implement an environmentally-friendly process by reducing the amount of wastewater generated compared to conventional extraction methods because the method does not use an excessive amount of strong acid.

The lithium extraction method according to the exemplary embodiments of the present application can implement an environmentally-friendly process because a small amount of wastewater remains as a by-product.

The lithium extraction method according to the exemplary embodiments of the present application can reduce carbon dioxide by using captured carbon dioxide as a reactant.

### DESCRIPTION OF DRAWINGS

FIG. 1 is a schematic diagram of a reaction in which a lithium-containing material, nitric acid, HₓRuO₂, carbon dioxide, and hydrogen are catalytically reacted at a high pressure to obtain lithium carbonate or lithium hydroxide; and an ammonium compound according to one exemplary embodiment of the present application.

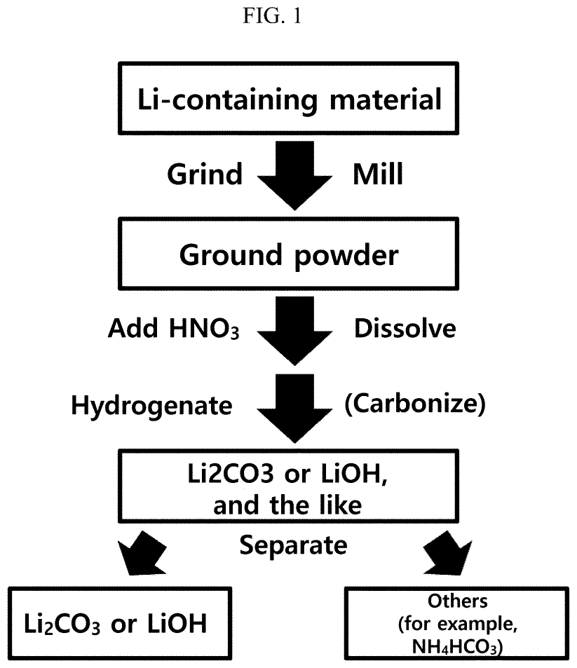

FIG. 2 is a schematic diagram of a reaction in which brine, sodium nitrate, HₓRuO₂, carbon dioxide, and hydrogen are catalytically reacted at a high pressure to obtain lithium carbonate or lithium hydroxide; and an ammonium compound.

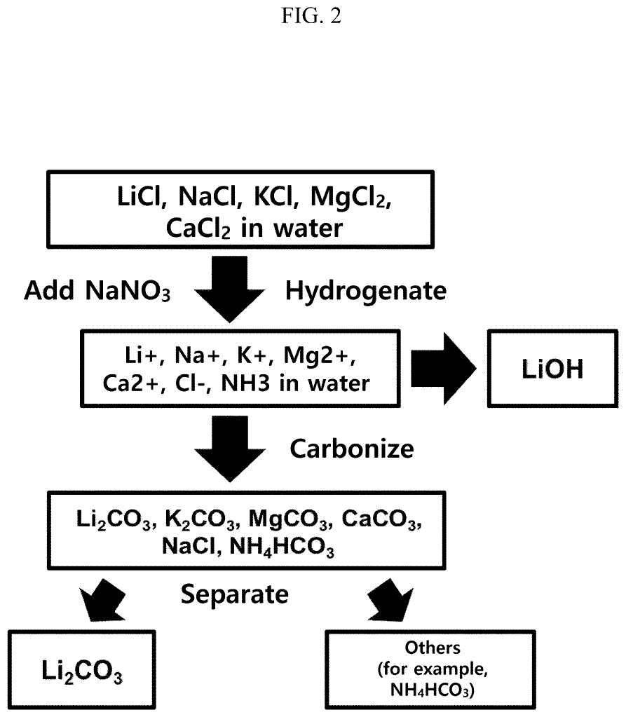

FIG. 3 is a powder X-ray diffraction analysis graph of lithium carbonate (Li₂CO₃) prepared according to Example 1-1 of the present application.

FIG. 4 is a powder X-ray diffraction analysis graph of ammonium bicarbonate (NH₄HCO₃) prepared according to Example 1-1 of the present application.

FIG. 5 is a powder X-ray diffraction analysis graph of lithium carbonate (Li₂CO₃) and sodium chloride (NaCl) prepared according to Example 2-1 of the present application.

FIG. 6 is a powder X-ray diffraction analysis graph of magnesium carbonate (MgCO₃) prepared according to Example 2-1 of the present application.

### BEST MODE

Hereinafter, exemplary embodiments and examples of the present application will be described in detail with reference to the accompany drawings so that the present application can be easily practiced by those skilled in the art to which the present application pertains. However, it should be understood that the present application may be implemented in various different forms and is not limited to the exemplary embodiments and examples described herein. In addition, in the drawings, parts irrelevant to the description have been omitted to clearly explain the present application, and similar parts have similar reference numerals throughout the specification.

Throughout the present specification, when a certain element is referred to as being “connected to” another element, this includes not only cases in which the element is directly connected to the other element but cases in which the element is “electrically connected to” the other element with one or more intervening elements interposed therebetween.

Throughout the present specification, when a certain element is referred to as being “on” another element, this includes not only cases in which the element comes in contact with the other element but cases in which there are other elements interposed between the two intervening elements.

Throughout the present specification, unless otherwise specifically specified, when a certain element is referred to as “including” another element, this means that the element may include other elements rather than excluding the other elements.

The terms “approximately,” “substantially,” and the like used herein are used in a meaning that is at or close to the numerical value when manufacturing and material tolerances inherent in the meanings mentioned herein are presented, and are used to prevent unscrupulous infringers from unfairly exploiting the disclosure in which exact or absolute values are mentioned to aid understanding of the present application.

The term “step of” as used throughout the present specification does not mean “step for.”

Throughout the present specification, the term “combination(s) thereof” included in the expressions in the Markush format refers to one or more mixtures or combinations selected from the group consisting of the elements described in the expressions in the Markush format, and means that the term includes one or more selected from the group consisting of the elements. Throughout the present specification, references to “A and/or B” mean “A or B, or A and B.”

Hereinafter, exemplary embodiments of the present application will be described in detail, but the present application is not limited thereto.

A first aspect of the present application provides a method for extracting lithium, which includes obtaining lithium by catalytically reacting a lithium-containing material; nitric acid or nitrate ions; and hydrogen.

According to one exemplary embodiment of the present application, carbon dioxide may be further included as a reactant of the catalytic reaction.

According to one exemplary embodiment of the present application, the pressure of the carbon dioxide may be in the range of approximately 0.1 MPa to approximately 5 MPa. According to one exemplary embodiment of the present application, the pressure of the carbon dioxide may be approximately 0.1 MPa to approximately 5 MPa, approximately 0.1 MPa to approximately 4 MPa, approximately 0.1 MPa to approximately 3 MPa, approximately 0.1 MPa to approximately 2 MPa, approximately 0.1 MPa to approximately 1 MPa, approximately 0.3 MPa to approximately 5 MPa, approximately 0.3 MPa to approximately 4 MPa, approximately 0.3 MPa to approximately 3 MPa, approximately 0.3 MPa to approximately 2 MPa, or approximately 0.3 MPa to approximately 1 MPa. According to one exemplary embodiment of the present application, the pressure of the carbon dioxide may be most preferably approximately 0.5 MPa.

According to one exemplary embodiment of the present application, the lithium-containing material may include one or more selected from brine, lithium oxide, lithium sulfate, lithium nitrate, lithium phosphate, lithium sulfide, lithium silicate, lithium carbonate, lithium chloride, lithium titanate, spodumene, petalite, eucryptite, lepidolite, amblygonite, hectorite, natural materials, process by-products or waste, and metal alloy materials.

According to one exemplary embodiment of the present application, the natural materials may include spodumene ore, and the process by-products or waste may include one or more selected from slag and sludge, but the present application is not limited thereto.

According to one exemplary embodiment of the present application, the lithium-containing material may include one or more selected from Li, Na, K, Rb, Ni, Co, Mn, Si, Al, Ti, and Fe, and a non-limiting example thereof may be an oxide, a sulfate, a nitrate, a phosphate, a chloride, a fluoride, a carbonate, a hydroxide, or a sulfide.

According to one exemplary embodiment of the present application, the brine may include a lithium salt. According to one exemplary embodiment of the present application, the brine may include one or more salts in addition to the lithium salt. As a non-limiting example, the brine may include one or more salts selected from lithium chloride, sodium chloride, potassium chloride, magnesium chloride, and calcium chloride.

According to one exemplary embodiment of the present application, the concentration of the nitric acid or nitrate ions may be in the range of approximately 0.1 M to approximately 10 M. According to one exemplary embodiment of the present application, the concentration of the nitric acid or nitrate ions may be approximately 0.1 M to approximately 10 M, approximately 0.1 M to approximately 8 M, approximately 0.1 M to approximately 6 M, approximately 0.1 M to approximately 4 M, approximately 0.1 M to approximately 2 M, approximately 1 M to approximately 10 M, approximately 1 M to approximately 8 M, approximately 1 M to approximately 6 M, approximately 1 M to approximately 4 M, approximately 1 M to approximately 2 M, approximately 2 M to approximately 10 M, approximately 2 M to approximately 8 M, approximately 2 M to approximately 6 M, approximately 2 M to approximately 4 M, approximately 3 M to approximately 10 M, approximately 3 M to approximately 8 M, approximately 3 M to approximately 6 M, approximately 3 M to approximately 4 M, approximately 4 M to approximately 10 M, approximately 4 M to approximately 8 M, approximately 4 M to approximately 6 M, approximately 5 M to approximately 10 M, approximately 5 M to approximately 8 M, approximately 5 M to approximately 6 M, approximately 6 M to approximately 10 M, approximately 6 M to approximately 8 M, approximately 7 M to approximately 10 M, approximately 7 M to approximately 8 M, or approximately 8 M to approximately 10 M.

According to one exemplary embodiment of the present application, the nitrate ions may be derived from a material selected from NaNO₃, KNO₃, HNO₃, Ca(NO₃)₂, Ba(NO₃)₂, and AgNO₃. According to one exemplary embodiment of the present application, the nitrate ions may be derived from a salt selected from NaNO₃, KNO₃, Ca(NO₃)₂, Ba(NO₃)₂, and AgNO₃.

According to one exemplary embodiment of the present application, the catalyst may be selected from a metal, alloy or oxide including one or more selected from titanium (Ti), vanadium (V), chromium (Cr), manganese (Mn), iron (Fe), cobalt (Co), nickel (Ni), copper (Cu), zinc (Zn), molybdenum (Mo), indium (In), tin (Sn), phosphorus (P), aluminum (Al), silicon (Si), ruthenium (Ru), rhodium (Rh), palladium (Pd), silver (Ag), tungsten (W), rhenium (Re), osmium (Os), iridium (Ir), platinum (Pt), and gold (Au).

According to one exemplary embodiment of the present application, the catalyst may include a ruthenium oxide represented by the following Chemical Formula I:

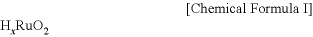

wherein 0<x≤4.

According to one exemplary embodiment of the present application, when the catalyst has a particle diameter of approximately 10 nm or less, the reaction activity may be enhanced, but the present application is not limited thereto. According to one exemplary embodiment of the present application, the catalyst may have a particle diameter of approximately 10 nm or less, approximately 8 nm or less, approximately 6 nm or less, or approximately 4 nm or less.

According to one exemplary embodiment of the present application, since the catalyst does not melt or its structure does not collapse during the reaction, the reaction may be performed for a long time.

According to one exemplary embodiment of the present application, the catalyst may be separated and recovered after the reaction is completed, and then reused.

According to one exemplary embodiment of the present application, it is desirable in terms of activity and/or stability to use a catalyst including a ruthenium oxide represented by Chemical Formula I in the reaction, but another metal or metal salt may be additionally used as an auxiliary catalyst.

According to one exemplary embodiment of the present application, the catalyst may be used in an amount of approximately 0.1 parts by weight to approximately 50 parts by weight based on 100 parts by weight of the lithium-containing material. According to one exemplary embodiment of the present application, the catalyst may be used in an amount of approximately 0.1 parts by weight to approximately 50 parts by weight, approximately 0.1 parts by weight to approximately 40 parts by weight, approximately 0.1 parts by weight to approximately 30 parts by weight, approximately 0.1 parts by weight to approximately 20 parts by weight, approximately 0.1 parts by weight to approximately 10 parts by weight, approximately 1 part by weight to approximately 50 parts by weight, approximately 1 part by weight to approximately 40 parts by weight, approximately 1 part by weight to approximately 30 parts by weight, approximately 1 part by weight to approximately 20 parts by weight, approximately 1 part by weight to approximately 10 parts by weight, approximately 10 parts by weight to approximately 50 parts by weight, approximately 10 parts by weight to approximately 40 parts by weight, approximately 10 parts by weight to approximately 30 parts by weight, approximately 10 parts by weight to approximately 20 parts by weight, approximately 20 parts by weight to approximately 50 parts by weight, approximately 20 parts by weight to approximately 40 parts by weight, approximately 20 parts by weight to approximately 30 parts by weight, approximately 30 parts by weight to approximately 50 parts by weight, approximately 30 parts by weight to approximately 40 parts by weight, or approximately 40 parts by weight to approximately 50 parts by weight based on 100 parts by weight of the lithium-containing material. According to one exemplary embodiment of the present application, when the weight ratio of the catalyst to the lithium-containing material is approximately 0.1 or less, it may take 24 hours or more for the reaction to be completed, but the present application is not limited thereto.

According to one exemplary embodiment of the present application, the catalytic reaction may be performed in a hydrothermal reactor.

According to one exemplary embodiment of the present application, the catalytic reaction may be performed at a temperature range of approximately 20° C. to approximately 200° C. According to one exemplary embodiment of the present application, the catalytic reaction may be performed at a temperature range of approximately 20° C. to approximately 200° C., approximately 20° C. to approximately 170° C., approximately 20° C. to approximately 150° C., approximately 20° C. to approximately 130° C., approximately 20° C. to approximately 110° C., approximately 40° C. to approximately 200° C., approximately 40° C. to approximately 170° C., approximately 40° C. to approximately 150° C., approximately 40° C. to approximately 130° C., approximately 40° C. to approximately 110° C., approximately 60° C. to approximately 200° C., approximately 60° C. to approximately 170° C., approximately 60° C. to approximately 150° C., approximately 60° C. to approximately 130° C., approximately 60° C. to approximately 110° C., approximately 80° C. to approximately 200° C., approximately 80° C. to approximately 170° C., approximately 80° C. to approximately 150° C., approximately 80° C. to approximately 130° C., or approximately 80° C. to approximately 110° C., but the present application is not limited thereto. According to one exemplary embodiment of the present application, the catalytic reaction may be most preferably performed at approximately 100° C.

According to one exemplary embodiment of the present application, the pressure of the hydrogen may be in the range of approximately 0.1 MPa to approximately 10 MPa. According to one exemplary embodiment of the present application, the pressure of the hydrogen may be approximately 0.1 MPa to approximately 10 MPa, approximately 0.1 MPa to approximately 9 MPa, approximately 0.1 MPa to approximately 8 MPa, approximately 0.1 MPa to approximately 7 MPa, approximately 0.1 MPa to approximately 6 MPa, approximately 1 MPa to approximately 10 MPa, approximately 1 MPa to approximately 9 MPa, approximately 1 MPa to approximately 8 MPa, approximately 1 MPa to approximately 7 MPa, approximately 1 MPa to approximately 6 MPa, approximately 2 MPa to approximately 10 MPa, approximately 2 MPa to approximately 9 MPa, approximately 2 MPa to approximately 8 MPa, approximately 2 MPa to approximately 7 MPa, approximately 2 MPa to approximately 6 MPa, approximately 3 MPa to approximately 10 MPa, approximately 3 MPa to approximately 9 MPa, approximately 3 MPa to approximately 8 MPa, approximately 3 MPa to approximately 7 MPa, approximately 3 MPa to approximately 6 MPa, approximately 4 MPa to approximately 10 MPa, approximately 4 MPa to approximately 9 MPa, approximately 4 MPa to approximately 8 MPa, approximately 4 MPa to approximately 7 MPa, or approximately 4 MPa to approximately 6 MPa.

According to one exemplary embodiment of the present application, the pressure ratio of the carbon dioxide and the hydrogen (carbon dioxide:hydrogen) may be in the range of approximately 1:1 to approximately 1:50. For example, the pressure ratio of the carbon dioxide and the hydrogen (carbon dioxide:hydrogen) may be approximately 1:1 to approximately 1:50, approximately 1:1 to approximately 1:40, approximately 1:1 to approximately 1:30, approximately 1:1 to approximately 1:20, approximately 1:1 to approximately 1:10, approximately 1:1 to approximately 1:5, or approximately 1:1 to approximately 1:4.

According to one exemplary embodiment of the present application, the catalytic reaction may be performed under solution conditions including a solvent, but the present application is not limited thereto.

According to one exemplary embodiment of the present application, the solvent may be selected from water, methanol, and ethanol.

According to one exemplary embodiment of the present application, the lithium may be obtained in a form dissolved in a solution or in the form of a precipitate.

According to one exemplary embodiment of the present application, the lithium may be obtained in one or more forms selected from lithium carbonate, lithium phosphate, lithium sulfate, lithium hydroxide, and hydrates thereof.

According to one exemplary embodiment of the present application, the lithium may be obtained as a precipitate in the solution through filtration, but the present application is not limited thereto. According to one exemplary embodiment of the present application, the ammonia may be obtained in the form of an ammonium compound by adding an acid to the solution, but the present application is not limited thereto.

According to one exemplary embodiment of the present application, the lithium may be obtained as a single element or as an ionic compound. The compound may be obtained as a salt, and the type thereof is not particularly limited. As a non-limiting example, the compound may be a carbonate, a phosphate, a sulfate, or a hydrate.

According to one exemplary embodiment of the present application, the lithium extraction method may further include a pretreatment step of heat-treating the lithium-containing material.

According to one exemplary embodiment of the present application, the heat treatment may be performed by adding the ore itself and heat-treating the ore, but the present application is not limited thereto.

According to one exemplary embodiment of the present application, the heat treatment may be performed by further adding an additive, but the present application is not limited thereto.

According to one exemplary embodiment of the present application, the additive may be selected from iron oxide (Fe₂O₃), sodium carbonate (Na₂CO₃), calcium carbonate (CaCO₃), alumina (Al₂O₃), and silica (SiO₂), but the present application is not limited thereto.

According to one exemplary embodiment of the present application, the heat treatment may be performed at a temperature range of approximately 800° C. to approximately 1,200° C. According to one exemplary embodiment of the present application, the heat treatment may be performed at a temperature range of approximately 800° C. to approximately 1,200° C., approximately 800° C. to approximately 1,150° C., approximately 850° C. to approximately 1,200° C., or approximately 850° C. to approximately 1,150° C. According to one exemplary embodiment of the present application, the heat treatment may be most preferably performed at a temperature range of approximately 900° C. to approximately 1,100° C.

According to one exemplary embodiment of the present application, the heat treatment may be performed in a gas atmosphere including one or more selected from oxygen, nitrogen, hydrogen, and carbon dioxide; or in air. According to one exemplary embodiment of the present application, the heat treatment may be most preferably performed in air.

According to one exemplary embodiment of the present application, the lithium extraction method may further include a pretreatment step of treating the spent cathode material or the metal compound with an acid.

According to one exemplary embodiment of the present application, the acid used in the acid treatment may include one or more selected from sulfuric acid, nitric acid, hydrochloric acid, and phosphoric acid.

According to one exemplary embodiment of the present application, the acid treatment may be performed at a temperature range of approximately 0° C. to approximately 300° C., but the present application is not limited thereto. According to one exemplary embodiment of the present application, the acid treatment may be performed at a temperature range of approximately 0° C. to approximately 300° C., approximately 0° C. to approximately 200° C., approximately 0° C. to approximately 100° C., approximately 100° C. to approximately 300° C., approximately 100° C. to approximately 200° C., or approximately 200° C. to approximately 300° C., but the present application is not limited thereto.

According to one exemplary embodiment of the present application, the acid treatment may be performed in a gas atmosphere including one or more selected from oxygen, nitrogen, argon, hydrogen, and carbon dioxide; or in air.

According to one exemplary embodiment of the present application, ammonia and/or an ammonium compound may be additionally prepared through the lithium extraction method. According to one exemplary embodiment of the present application, the ammonium compound may be NH₄HCO₃.

A second aspect of the present application provides a ruthenium oxide catalyst represented by the following Chemical Formula I and having a monoclinic crystal structure, wherein the ruthenium oxide catalyst is used in the lithium extraction method according to the first aspect:

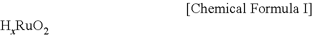

wherein 0<x≤4.

Detailed description of parts that overlap with the first aspect of the present application is omitted, but the contents described in the first aspect of the present application may be equally applied even when the description is omitted in the second aspect of the present application.

According to one exemplary embodiment of the present application, in Chemical Formula I above, x (an atomic ratio of hydrogen) may be greater than 0 and 4 or less, greater than 0 and 3.5 or less, greater than 0 and 3 or less, greater than 0 and 2.5 or less, greater than 0 and 2 or less, greater than 0 and 1.5 or less, greater than 0 and 1.2 or less, approximately 0.1 to approximately 3.5, approximately 0.1 to approximately 3, approximately 0.1 to approximately 2.5, approximately 0.1 to approximately 2, approximately 0.1 to approximately 1.5, approximately 0.1 to approximately 1.2, approximately 0.2 to approximately 3.5, approximately 0.2 to approximately 3, approximately 0.2 to approximately 2.5, approximately 0.2 to approximately 2, approximately 0.2 to approximately 1.5, approximately 0.2 to approximately 1.2, approximately 0.3 to approximately 3.5, approximately 0.3 to approximately 3, approximately 0.3 to approximately 2.5, approximately 0.3 to approximately 2, approximately 0.3 to approximately 1.5, approximately 0.3 to approximately 1.2, approximately 0.4 to approximately 3.5, approximately 0.4 to approximately 3, approximately 0.4 to approximately 2.5, approximately 0.4 to approximately 2, approximately 0.4 to approximately 1.5, or approximately 0.4 to approximately 1.2, but the present application is not limited thereto. According to one exemplary embodiment of the present application, in Chemical Formula I above, x may be approximately 0.4 to approximately 1.2.

According to one exemplary embodiment of the present application, in Chemical Formula I above, the closer x (atomic ratio of hydrogen) is to approximately 1, the easier it is to produce a monoclinic ruthenium oxide. Specifically, when the ratio of hydrogen is approximately 0.6 to approximately 1.4, a monoclinic ruthenium oxide may be more easily produced. Here, when x is 0 in Chemical Formula I, since a structural transition to a tetragonal rutile ruthenium oxide may occur, it is desirable to maintain the content of hydrogen.

According to one exemplary embodiment of the present application, the atomic ratio of hydrogen included in Chemical Formula I above may be calculated by thermogravimetric analysis (TGA). Specifically, in the analysis using thermogravimetry, a solid sample may be put into a platinum container, and a change in weight of the solid sample may be measured while increasing the temperature. All hydrogen included in the monoclinic ruthenium oxide (HₓRuO₂) is removed and converted to a tetragonal ruthenium oxide (RuO₂). The amount of hydrogen may be quantitatively analyzed from the change in weight according to the temperature.

According to one exemplary embodiment of the present application, the ruthenium oxide may have diffraction peaks observed at positions corresponding to incident angles (2θ) of 18.38°<2θ<18.42°, 25.45°<2θ<25.51°, 26.26°<2θ<26.32°, 33.45°<2θ<33.51°, 35.28°<2θ<35.34°, 36.24°<2θ<36.30°, 37.32°<2θ<37.38°, 39.55°<2θ<39.61°, 40.61° <2θ<40.67°, 41.46°<2θ<41.52°, 49.17°<2θ<49.23°, 52.31°<2θ<52.37°, 54.03°<2θ <54.09°, 54.70°<2θ<54.76°, 55.95°<2θ<56.01°, 59.97°<2θ<60.03°, 60.40°<2θ<60.46°, 61.92°<2θ<61.98°, 63.94°<2θ<64.00°, 65.79°<2θ<65.85°, and 69.13°<2θ<69.19°, as measured by X-ray powder diffractometry (Cu Ka radiation). According to one exemplary embodiment of the present application, the ruthenium oxide may have diffraction peaks observed at positions corresponding to incident angles (2θ) of 18.40°, 25.48°, 26.29°, 33.48°, 35.31°, 36.27°, 37.35°, 39.58°, 40.64°, 41.49°, 49.20°, 52.34°, 54.06°, 54.73°, 55.98°, 58.00°, 60.43°, 61.95° 63.97°, 65.82°, and 69.16°, as measured by X-ray powder diffractometry (Cu Ka radiation).

According to one exemplary embodiment of the present application, the ruthenium oxide may have a structure with a monoclinic space group P2₁/c, C2/m, P2/c, C2/c, P2/m, or P2₁/m, but the present application is not limited thereto.

According to one exemplary embodiment of the present application, the unit cell in the monoclinic crystal structure of the ruthenium oxide catalyst may be defined by the lattice constants a to c and an angle β between corners.

According to one exemplary embodiment of the present application, in the monoclinic crystal structure, 5 Å≤a≤6 Å, 5 Å≤b≤6 Å, and 5 Å≤c≤6, and the beta (B) angle may be in the range of approximately 110° to approximately 120°. For example, a to c may each independently be approximately 5 Å to approximately 6 Å, approximately 5.1 Å to approximately 6 Å, approximately 5.2 Å to approximately 6 Å, approximately 5.3 Å to approximately 6 Å, approximately 5 Å to approximately 5.8 Å, approximately 5.1 Å to approximately 5.8 Å, approximately 5.2 Å to approximately 5.8 Å, approximately 5.3 Å to approximately 5.8 Å, approximately 5 Å to approximately 5.6 Å, approximately 5.1 Å to approximately 5.6 Å, approximately 5.2 Å to approximately 5.6 Å, approximately 5.3 Å to approximately 5.6 Å, approximately 5 Å to approximately 5.4 Å, approximately 5.1 Å to approximately 5.4 Å, approximately 5.2 Å to approximately 5.4 Å, approximately 5.3 Å to approximately 5.4 Å, or approximately 5.35 Å to approximately 5.4 Å, b may be approximately 5 Å to approximately 6 Å, approximately 5 Å to approximately 5.8 Å, approximately 5 Å to approximately 5.6 Å, approximately 5 Å to approximately 5.4 Å, approximately 5 Å to approximately 5.2 Å, or approximately 5 Å to approximately 5.1 Å, and the beta (B) angle may be approximately 110° to approximately 120°, approximately 112° to approximately 120°, approximately 114° to approximately 120°, approximately 110° to approximately 118°, approximately 112° to approximately 118°, approximately 114° to approximately 118°, approximately 110° to approximately 116°, approximately 112° to approximately 116°, or approximately 114° to approximately 116°.

According to one exemplary embodiment of the present application, in the monoclinic crystal structure, a=5.3533 Å, b=5.0770 Å, and c=5.3532 Å, and the beta (B) angle may be 115.9074°, but the present application is not limited thereto.

Hereinafter, the present application will be described in more detail using examples. However, it should be understood that the following examples are provided only to help understand the present application, and are not intended to limit the contents of the present application.

### MODE FOR INVENTION

### Example 1-1

After spodumene ore was heat-treated at 1,000° C. for 10 hours, it was confirmed through elemental analysis that the content of lithium in the spodumene was 2.62% by weight. 0.5 g of the spodumene ore, 20 mg of HₓRuO₂ (0.15 mmol), and 2 mL of 1 M HNO₃ were put into a hydrothermal reactor, and the interior of the hydrothermal reactor was filled to a carbon dioxide pressure of 0.5 MPa and a hydrogen pressure of 2.0 MPa. Thereafter, the reaction was performed at 100° C. for 20 hours. After the reaction was completed, the hydrothermal reactor was cooled to room temperature, and the generated precipitate and residual solution were separated.

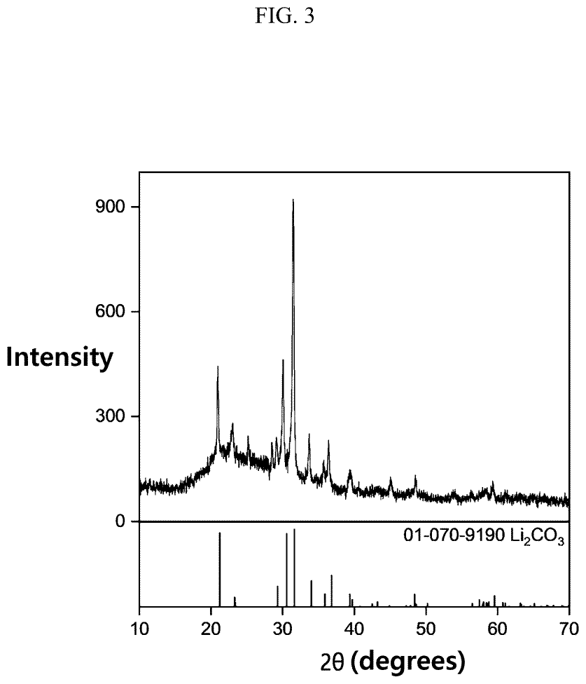

The precipitate was washed with water and separated into a supernatant solution and a powder that did not dissolve in water. It was confirmed through powder X-ray diffraction analysis that the powder obtained by drying the supernatant solution had a crystalline phase of Li₂CO₃ (see FIG. 3). The yield of generated Li₂CO₃ based on the elemental analysis of spodumene ore was 52.3%.

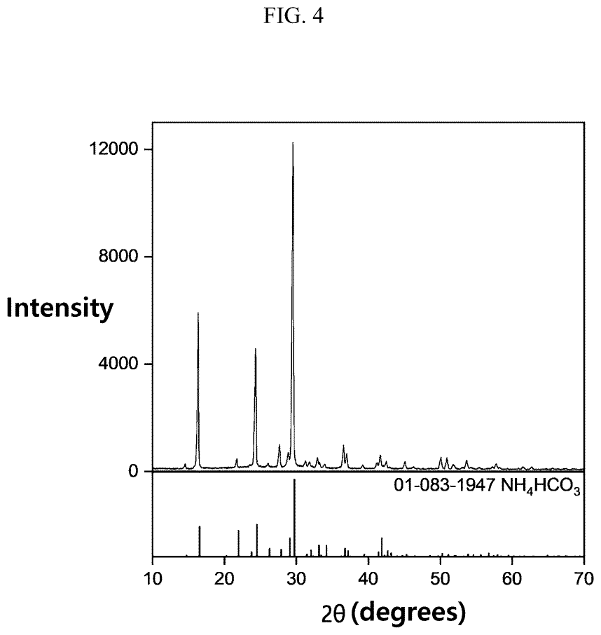

After the reaction, acetone was added to the residual solution. Then, the resulting mixture was separated and dried to obtain a white powder. As a result, it was confirmed through X-ray powder diffraction analysis that the white powder was NH₄HCO₃ (see FIG. 4).

### Example 1-2

This reaction was carried out in the same manner as in Example 1-1, except that 0.090 g of Li₂SiO₃ (1.00 mmol) was used as a reactant. After the reaction was completed, it was confirmed through X-ray powder diffraction analysis that the generated precipitate had a crystalline phase of Li₂CO₃, and the yield of Li₂CO₃ generated based on Li₂SiO₃ was 86.8%. After the reaction, acetone was added to the residual solution. Then, the resulting mixture was separated and dried to obtain a white powder. As a result, it was confirmed through X-ray powder diffraction analysis that the white powder was NH₄HCO₃.

### Example 1-3

This reaction was carried out in the same manner as in Example 1-1, except that the reaction was carried out using 0.138 g of LiNO₃ (2.00 mmol) and 2 mL of distilled water as reactants. After the reaction was completed, it was confirmed through X-ray powder diffraction analysis that the generated precipitate had a crystalline phase of Li₂CO₃, and the yield of Li₂CO₃ generated based on LiNO₃ was 90.7%. After the reaction, acetone was added to the residual solution, and the resulting mixture was then separated and dried to obtain a white powder. As a result, it was confirmed through X-ray powder diffraction analysis that the white powder was NH₄HCO₃.

The component composition of the brine used in Examples 2-1, 2-3 to 2-9, and 3-2 to 3-4 is as shown in Table 1 below:

TABLE 1

| Metal chloride | Concentration (M) |
|---|---|
| Lithium chloride (LiCl) | 5.25 |
| Sodium chloride (NaCl) | 1.86 |
| Potassium chloride (KCl) | 0.56 |
| Magnesium chloride (MgCl₂) | 1.67 |
| Calcium chloride (CaCl₂) | 0.01 |

### Example 2-1

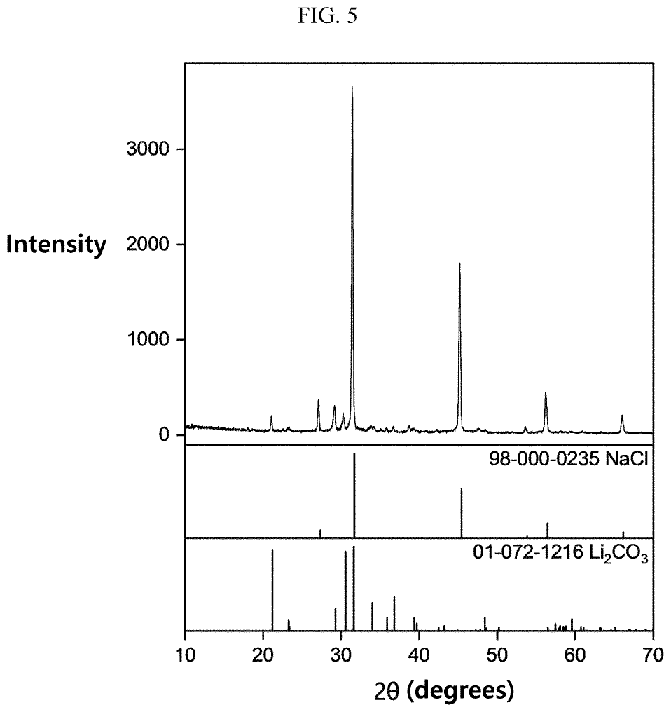

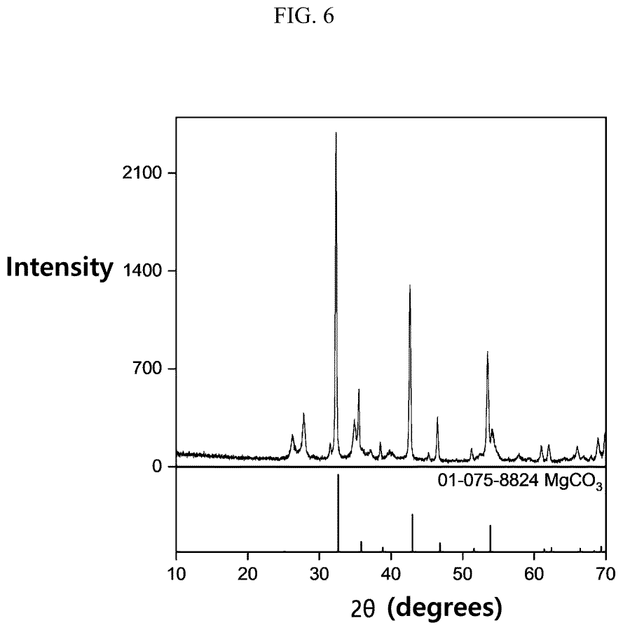

0.5 mL of brine, 1.5 mL of distilled water, 20 mg of a catalyst (HₓRuO₂, 0.15 mmol) and 0.469 g of sodium nitrate (NaNO₃, 5.52 mmol) were put into a hydrothermal reactor, and the interior of the hydrothermal reactor was filled to a carbon dioxide pressure of 1.0 MPa and a hydrogen pressure of 4.0 MPa. Thereafter, the reaction was performed at 100° C. for 10 hours. After the reaction was completed, the hydrothermal reactor was cooled to room temperature, and the generated precipitate and residual solution were separated. Then, the precipitate was washed with water and separated into a supernatant solution and a powder that did not dissolve in water. It was confirmed from the crystal structure determined by the powder X-ray diffraction method that the powder obtained by drying the supernatant solution was Li₂CO₃ and NaCl (see FIG. 5), and the powder that did not dissolve in water was MgCO₃ (see FIG. 6). The yield of Li₂CO₃ generated based on the lithium of the brine was 98.5%.

Analysis of the residual solution using ultraviolet-visible spectroscopy revealed that no nitrogen oxide ions (NO₃⁻ and NO₂⁻) were detected, indicating that all nitrate ions were reduced to ammonia or nitrogen. Acetone was added to the residual solution, and the resulting mixture was separated and dried to obtain a white powder. As a result, it was confirmed through X-ray powder diffraction analysis that the white powder was ammonium bicarbonate (NH₄HCO₃). The yield of NH₄HCO₃ calculated based on NaNO₃ was 78.2%.

### <Brine Change>

### Example 2-2

This reaction was carried out in the same manner as in Example 2-1, except that 0.5 mL of a 5.25 M LiCl solution was used as brine. After the reaction was completed, it was confirmed from the crystal structure determined by X-ray diffraction analysis that the separated precipitate was Li₂CO₃. Acetone was added to the residual solution, and the resulting mixture was then separated and dried to obtain a white powder. As a result, it was confirmed through X-ray powder diffraction analysis that the white powder was NH₄HCO₃. The yields of Li₂CO₃ and NH₄HCO₃ were 98.1% and 79.5%, respectively.

### <Nitrogen Compound Changes>

### Example 2-3

This reaction was carried out in the same manner as in Example 2-1, except that 0.558 g of KNO₃ (5.52 mmol) was used instead of NaNO₃ as a reactant. After the reaction was completed, the Li₂CO₃ included in the precipitate was dissolved in water and separated from other carbonate compounds. As a result, it was confirmed from the crystal structure determined by X-ray diffraction analysis that the separated precipitate was Li₂CO₃. Acetone was added to the residual solution, and the resulting mixture was then separated and dried to obtain a white powder. As a result, it was confirmed through X-ray powder diffraction analysis that the white powder was NH₄HCO₃. The yields of Li₂CO₃ and NH₄HCO₃ were 97.5% and 67.5%, respectively.

### Example 2-4

This reaction was carried out in the same manner as in Example 2-1, except that 3 mL of 2 N HNO₃ was used instead of NaNO₃ as a reactant. After the reaction was completed, the Li₂CO₃ included in the precipitate was dissolved in water and separated from other carbonate compounds. As a result, it was confirmed from the crystal structure determined by X-ray diffraction analysis that the separated precipitate was Li₂CO₃. Acetone was added to the residual solution, and the resulting mixture was then separated and dried to obtain a white powder. As a result, it was confirmed through X-ray powder diffraction analysis that the white powder was NH₄HCO₃. The yields of Li₂CO₃ and NH₄HCO₃ were are each less than 5%.

### Example 2-5

This reaction was carried out in the same manner as in Example 2-1, except that 0.651 g of Ca(NO₃)₂4H₂O (2.76 mmol) was used instead of NaNO₃ as a reactant. After the reaction was completed, the Li₂CO₃ included in the precipitate was dissolved in water and separated from other carbonate compounds. As a result, it was confirmed from the crystal structure determined by X-ray diffraction analysis that the separated precipitate was Li₂CO₃. Acetone was added to the residual solution, and the resulting mixture was then separated and dried to obtain a white powder. As a result, it was confirmed through X-ray powder diffraction analysis that the white powder was NH₄HCO₃. The yields of Li₂CO₃ and NH₄HCO₃ were 35.8% and 27.2%, respectively.

### <Catalyst Type Changes>

### Example 2-6

This reaction was carried out in the same manner as in Example 2-1, except that ruthenium powder (15.2 mg, 0.15 mmol) was used instead of HₓRuO₂ as a catalyst. After the reaction was completed, a very small amount of a carbonate compound was generated, and the yields of the generated Li₂CO₃ and NH₄HCO₃ were estimated to be less than 5%.

### Example 2-7

This reaction was carried out in the same manner as in Example 2-1, except that platinum powder (29.3 mg, 0.15 mmol) was used as a catalyst. After the reaction was completed, the Li₂CO₃ included in the precipitate was dissolved in water and separated from other carbonate compounds. As a result, it was confirmed from the crystal structure determined by X-ray diffraction analysis that the separated precipitate was Li₂CO₃. Acetone was added to the residual solution, and the resulting mixture was then separated and dried to obtain a white powder. As a result, it was confirmed through X-ray powder diffraction analysis that the white powder was NH₄HCO₃. The yields of Li₂CO₃ and NH₄HCO₃ were 75.5% and 57.4%, respectively.

### Example 2-8

This reaction was carried out in the same manner as in Example 2-1, except that palladium powder (16.0 mg, 0.15 mmol) was used as a catalyst. After the reaction was completed, a very small amount of a carbonate compound was generated, and the yields of the generated Li₂CO₃ and NH₄HCO₃ were estimated to be less than 5%.

### Example 2-9

This reaction was performed in the same manner as in Example 2-1, except that nickel powder (8.8 mg, 0.15 mmol) was used as a catalyst. After the reaction was completed, a very small amount of a carbonate compound was generated, and the yields of the generated Li₂CO₃ and NH₄HCO₃ were estimated to be less than 5%.

### Example 3-1

After spodumene ore was heat-treated at 1,000° C. for 10 hours, it was confirmed through elemental analysis that the content of lithium in the spodumene was 2.62% by weight. 0.5 g of the spodumene ore, 20 mg (0.15 mmol) of HₓRuO₂, and 2 mL of 1 M HNO₃ were put into a hydrothermal reactor, and the interior of the hydrothermal reactor was filled to a hydrogen pressure of 3.0 MPa, and the reaction was performed at 100° C. for 20 hours. After the reaction was completed, the hydrothermal reactor was cooled to room temperature, and the generated precipitate and residual solution were separated.

After the reaction, it was confirmed through X-ray powder diffraction analysis that the precipitate was LiOH. The yield of LiOH based on elemental analysis of spodumene ore was 49.3%.

### Example 3-2

0.36 mL of brine, 3.64 mL of distilled water, 0.679 g (4.00 mmol) of AgNO₃, and 20 mg (0.15 mmol) of HₓRuO₂ were put into a hydrothermal reactor, and the inside of the hydrothermal reactor was filled to a hydrogen pressure of 3.0 MPa, and the reaction was then carried out at 100° C. for 10 hours. The component composition of the brine used in the reaction is as shown in Table 1 above. After the reaction was completed, the hydrothermal reactor was cooled to room temperature, and the precipitate and the residual solution were separated.

Analysis of the residual solution using ultraviolet-visible spectroscopy revealed that no nitrate ions (NO₃⁻ and NO₂⁻) were detected, indicating that all nitrate ions of the reactant were reduced to ammonia or nitrogen. The residual solution was dried to obtain crystals, and it was confirmed through X-ray powder diffraction analysis that the obtained crystals were LiOH·H₂O. The yield of the obtained LiOH·H₂O was 95.6%. It was confirmed through X-ray powder diffraction analysis that the precipitate was silver chloride (AgCl) and magnesium hydroxide (Mg(OH)₂).

### Example 3-3

This reaction was carried out in the same manner as in Example 3-2, except that 0.340 g (4.00 mmol) of NaNO₃ was used instead of AgNO₃ as a reactant. After the reaction was completed, the hydrothermal reactor was cooled to room temperature, and the HₓRuO₂ catalyst and the residual solution were separated.

The residual solution was dried to obtain crystals, and it was confirmed through X-ray powder diffraction analysis that the obtained crystals were LiOH and NaCl. The obtained crystals were dissolved in water again, reacted with carbon dioxide for an hour, and dried to obtain crystals. As a result, it was confirmed that the obtained crystals were Li₂CO₃ and NaCl. Li₂CO₃ and NaCl were separated by utilizing their different solubilities in water, and the mass and yield of the obtained Li₂CO₃ were 0.131 g (1.77 mmol) and 88.6%, respectively. It was confirmed that the precipitate was Mg(OH)₂.

### Example 3-4

This reaction was carried out in the same manner as in Example 3-2, except that 4 mL of 1 M HNO₃ was used instead of AgNO₃ and distilled water as reactants. After the reaction was completed, the hydrothermal reactor was cooled to room temperature, and the HₓRuO₂ catalyst and the residual solution were separated.

The residual solution was dried to obtain crystals, and it was confirmed through X-ray powder diffraction analysis that the obtained crystals were LiOH and LiCl, and the yield of LiOH was 36.6%. Also, it was confirmed that the pH of the residual solution was 8.3.

The residual solution was allowed to react with carbon dioxide at 1 atm for an hour, and then dried to obtain crystals. As a result, it was confirmed through X-ray powder diffraction analysis that the obtained crystals were Li₂CO₃ and LiCl, and the yield of Li₂CO₃ was 33.2%.

The above description of the present application is provided only for the purpose of illustration, and it would be understood by those skilled in the art to which the present application pertains that various changes and modifications may be made without departing from the technical spirit and essential features of the present application. Therefore, it is clear that the above-described illustrative embodiments are illustrative in all aspects and not restrictive. For example, each component described as a single type can be implemented in a distributed manner. Likewise, components described as distributed can be implemented in a combined manner.

The scope of the present application is defined by the following claims and their equivalents rather than by the detailed description of the present application. It shall be understood that all modifications and embodiments conceived from the meaning and scope of the claims and their equivalents are included in the scope of the inventive concept.

1. A method for extracting lithium, comprising:
obtaining lithium by catalytically reacting a lithium-containing material; nitric acid or nitrate ions; and hydrogen.

2. The method of claim 1, wherein carbon dioxide is further included as a reactant of the catalytic reaction; and
wherein the pressure of the carbon dioxide ranges from 0.1 MPa to 5 MPa.

3. The method of claim 1, wherein the lithium-containing material includes one or more selected from brine, lithium oxide, lithium sulfate, lithium nitrate, lithium phosphate, lithium iron phosphate, lithium sulfide, lithium silicate, lithium carbonate, lithium chloride, lithium titanate, spodumene, petalite, eucryptite, lepidolite, amblygonite, hectorite, natural materials, process by-products or wastes, metal alloy materials and one or more selected from Li, Na, K, Rb, Ni, Co, Mn, Si, Al, Ti, and Fe.

4. The method of claim 1, wherein the catalyst includes one or more selected from titanium (Ti), vanadium (V), chromium (Cr), manganese (Mn), iron (Fe), cobalt (Co), nickel (Ni), copper (Cu), zinc (Zn), molybdenum (Mo), indium (In), tin (Sn), phosphorus (P), aluminum (Al), silicon (Si), ruthenium (Ru), rhodium (Rh), palladium (Pd), silver (Ag), tungsten (W), rhenium (Re), osmium (Os), iridium (Ir), platinum (Pt), and gold (Au).

5. The method of claim 4, wherein the catalyst includes a ruthenium oxide represented by the following Chemical Formula I: 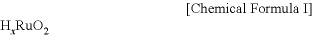
wherein 0<x≤4.

6. The method of claim 1, wherein the catalyst is used in an amount of 0.1 parts by weight to 50 parts by weight based on 100 parts by weight of the lithium-containing material.

7. The method of claim 1, wherein the catalytic reaction is performed in a hydrothermal reactor and wherein the catalytic reaction is performed at a temperature range of 20° C. to 200° C.

8. The method of claim 1, wherein the pressure of the hydrogen ranges from 0.1 MPa to 10 MPa.

9. The method of claim 1, wherein the catalytic reaction is performed under solution conditions including a solvent; and
wherein the solvent is selected from water, methanol, and ethanol.

10. The method of claim 1, wherein the lithium is obtained in a form dissolved in a solution or in the form of a precipitate; and
wherein the lithium is obtained in one or more forms selected from lithium carbonate, lithium phosphate, lithium sulfate, lithium hydroxide, and hydrates thereof.

11. The method of claim 1, further comprising a pretreatment step of heat-treating the lithium-containing material.

12. The method of claim 11, wherein the heat treatment is performed by further adding an additive; and
wherein the additive is selected from iron oxide (Fe₂O₃), sodium carbonate (Na₂CO₃), calcium carbonate (CaCO₃), alumina (Al₂O₃), and silica (SiO₂).

13. The method of claim 11, wherein the heat treatment is performed at a temperature range of 800° C. to 1,200° C.; and
wherein the heat treatment is performed in a gas atmosphere including one or more selected from oxygen, nitrogen, hydrogen, and carbon dioxide; or in air.

14. The method of claim 1, further comprising a pretreatment step of treating the lithium-containing material with an acid; and
wherein the acid used in the acid treatment includes one or more selected from sulfuric acid, nitric acid, hydrochloric acid, and phosphoric acid.

15. The method of claim 14, wherein the acid treatment is performed at a temperature range of 0° C. to 300° C.

16. The method of claim 14, wherein the acid treatment is performed in a gas atmosphere including one or more selected from oxygen, nitrogen, argon, hydrogen, and carbon dioxide; or in air.

17. A ruthenium oxide catalyst represented by the following Chemical Formula I and having a monoclinic crystal structure,
wherein the ruthenium oxide catalyst is used in the lithium extraction method defined in claim 1: 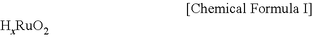
wherein 0<x≤4.

18. The ruthenium oxide catalyst of claim 17, wherein the ruthenium oxide catalyst has diffraction peaks observed at positions corresponding to incident angles (2θ) of 18.38°<2θ<18.42°, 25.45°<2θ<25.51°, 26.26°<2θ<26.32°, 33.45°<2θ<33.51°, 35.28°<2θ<35.34°, 36.24°<2θ<36.30°, 37.32°<2θ<37.38°, 39.55°<2θ<39.61°, 40.61°<2θ<40.67°, 41.46°<2θ<41.52°, 49.17°<2θ<49.23°, 52.31°<2θ<52.37°, 54.03°<2θ<54.09°, 54.70°<2θ <54.76°, 55.95°<2θ<56.01°, 59.97°<2θ<60.03°, 60.40°<2θ<60.46°, 61.92°<2θ<61.98°, 63.94°<2θ<64.00°, 65.79°<2θ<65.85°, and 69.13°<2θ<69.19°, as measured by X-ray powder diffractometry (Cu Kα radiation).

19. The ruthenium oxide catalyst of claim 17, wherein the ruthenium oxide catalyst has a structure with a monoclinic space group P2₁/c, C2/m, P2/c, C2/c, P2/m, or P2₁/m.

20. The ruthenium oxide catalyst of claim 17, wherein in the monoclinic crystal structure, 5 Å≤a≤6 Å, 5 Å≤b≤6 Å, and 5 Å≤c≤6 Å, and
the beta (β) angle ranges from 110° to 120°.
